(19) United States
(12) Patent Application Publication
(10) Pub. No.: US 2012/0005051 A1
(43) Pub. Date: Jan. 5, 2012

(54) Semi-Automated Customer Model-Based Service Deployment Into Data Centers

(75) Inventors: Yu Deng, Hawthorne, NY (US); Michael R. Head, Hawthorne, NY (US); Andrzej Kochut, Hawthorne, NY (US); Jonathan P. Munson, Hawthorne, NY (US); Anca Sailer, Hawthorne, NY (US); Hidayatullah Shaikh, Hawthorne, NY (US)

(73) Assignee: International Business Machines Corporation, Armonk, NY (US)

(21) Appl. No.: 12/829,154

(22) Filed: Jul. 1, 2010

(51) Int. Cl. G06F 15/173; G06Q 30/00

(52) U.S. Cl. 705/34; 709/226

(57) ABSTRACT

A non-transitory computer readable medium embodying instructions executed by a processor to perform a method for service creation and mapping between at least two support systems includes receiving a request for a new service, wherein the request includes resource requirement information and QOS requirement information corresponding to the new service, determining a location that the request originated from, identifying at least one data center within a communication range of the location, identifying at least one data center having resources complying with the resource requirement information, identifying at least one data center complying with the QOS requirement information, and deploying the new service into each data center that is within the communication range of the location, that has resources complying with the resource requirement information, and that complies with the QOS requirement information.

### BACKGROUND

1. Technical Field

The present disclosure relates to service deployment into data centers, and more particularly, to a graph based system and method for semi-automated service creation and optimized service mapping between a business support system (BSS) and an operations support system (OSS).

2. Discussion of Related Art

The emergence of cloud based networking has provided for improvements in the automation and scalability of data centers for service providers. However, the deployment of services into data centers prior to subscription to the services by customers is still accomplished manually. In addition, information relating to the location of customers and the service costs of deploying services from various data centers—which can be used to improve the deployment of services into data centers by reducing costs through flexible sourcing and targeting only cost-effective customers for new services—has not been utilized during the deployment of new services prior to customer subscriptions.

Therefore, a need exists for a system and method for a semi-automated service deployment into data centers that utilizes customer models of service subscriptions and data centers' models of resource types prior to the subscription of new services by a customer.

### BRIEF SUMMARY

According to an exemplary embodiment of the present disclosure, a non-transitory computer readable medium embodying instructions executed by a processor to perform a method for service creation and mapping between at least two support systems includes receiving a request for a new service, wherein the request includes resource requirement information and quality of service (QOS) requirement information corresponding to the new service, determining a location that the request originated from, identifying at least one data center within a communication range of the location, identifying at least one data center having resources complying with the resource requirement information, identifying at least one data center complying with the QOS requirement information, and deploying the new service into each data center that is within the communication range of the location, that has resources complying with the resource requirement information, and that complies with the QOS requirement information.

### BRIEF DESCRIPTION OF THE SEVERAL VIEWS OF THE DRAWINGS

Preferred embodiments of the present disclosure will be described below in more detail, with reference to the accompanying drawings:

FIG. 1 illustrates a services framework including a business support system (BSS) and an operations support system (OSS), according to an exemplary embodiment of the present disclosure;

FIG. 2 is a flowchart illustrating a method of deploying and provisioning a new service, according to an exemplary embodiment of the present disclosure;

FIG. 3 is a diagram illustrating the deployment of services based on customer location information, service cost information and QOS requirement information, according to an exemplary embodiment of the present disclosure;

FIG. 4 is a flowchart illustrating a method of deploying new services based on customer location information, service cost information and QOS requirement information, according to an exemplary embodiment of the present disclosure; and

FIG. 5 is a computer system for implementing a method according to an exemplary embodiment of the present disclosure.

### DETAILED DESCRIPTION

Exemplary embodiments of the present disclosure now will be described more fully hereinafter with reference to the accompanying drawings. This disclosure, may however, be embodied in many different forms and should not be construed as limited to the embodiments set forth herein.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Exemplary embodiments of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

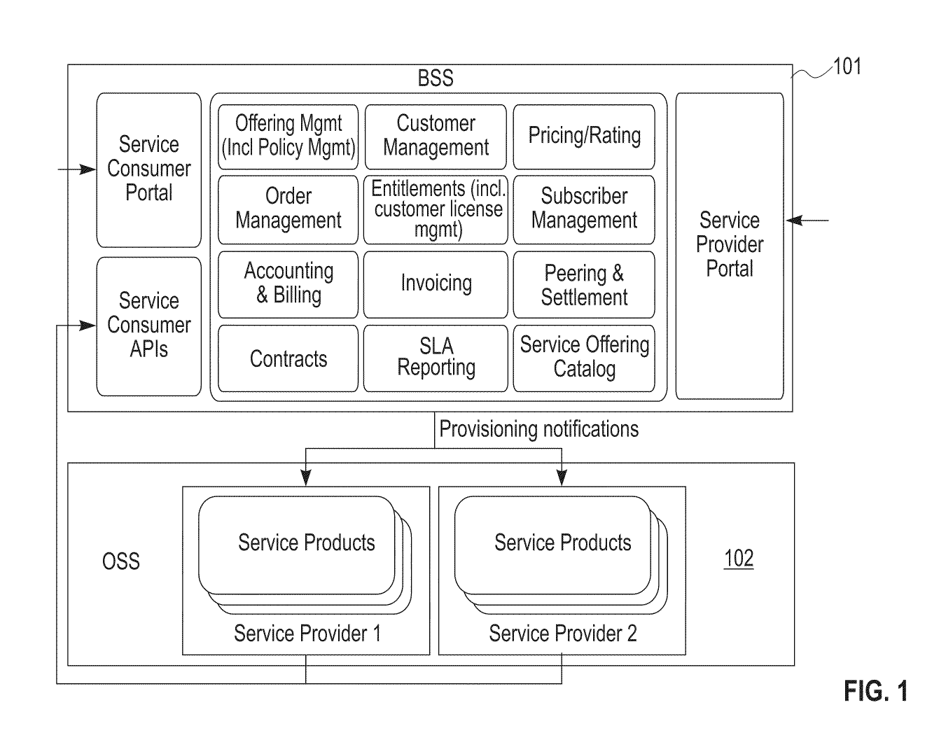

In an exemplary embodiment, services are created in a semi-automated fashion, and the mapping of services between a business support system (BSS) and an operations support system (OSS) is improved using a cloud services creation and deployment system based on graph-mapping. Various deployable end-to-end services are described and listed in a services catalog in the BSS. The BSS and OSS are linked to support these various end-to-end services. An exemplary embodiment of a services framework including a BSS 101 and an OSS 102 is illustrated in FIG. 1.

A BSS 101 provides business services that aid in the basic operations involved in running a business. For example, tasks such as customer management, order management, revenue management and product management are implemented using a BSS.

An OSS 102 provides operational services that process requests from a BSS 101 for a data center. Requests may include, for example, virtual machine creation and deletion, network and storage reservation and image management. The OSS 102 utilizes the configuration and current state of the data center when deploying these operational services. The OSS 102 allows a service provider to monitor, control, analyze and manage a communications network.

When a new service is deployed, potential operational environments are assigned based on the requirements of the service, a customer model and the resource types of potential data centers. The hardware requirements populated during the new service creation are subjected to the data centers' constraints. If a data center does not meet the hardware requirements, the new service is not assigned to that data center. If a data center meets the hardware requirements, the new service is assignable to that data center. Once all of the hardware requirements have been validated as supported by a data center by the OSS 102, the new service is considered deployable and the new service is listed in the services catalog in the BSS 101.

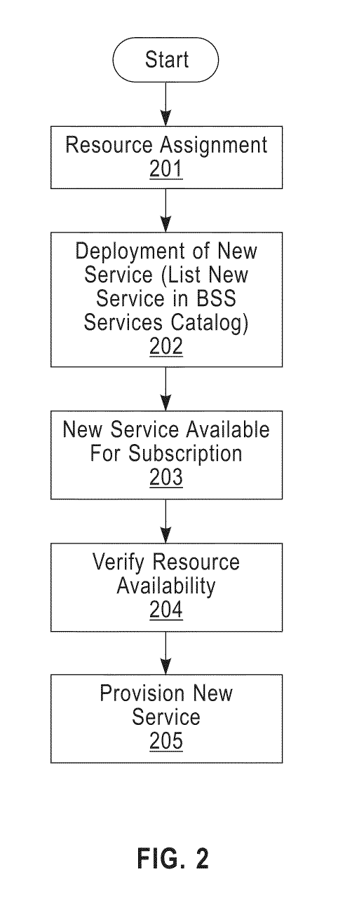

Referring to FIG. 2, a service provider may manage multiple services across multiple data centers. Before a new service can be deployed, a resource assignment process takes place at block 201. The resource assignment process identifies the data centers that are equipped with the appropriate resources capable of providing the new service. The availability of the needed resources at the data centers is not verified until the time of provisioning. Thus, all data centers that include resources capable of providing the new service are identified, regardless of whether the needed resources are currently available. Upon the successful assignment of resources at a data center, the new service is listed in the BSS services catalog and the new service is deployed at block 202. Once listed in the BSS services catalog, the new service is available for subscription by customers at block 203. Resource availability of all matching data centers is verified at block 204, and the new service is provisioned at the time of delivery upon customer subscription to the new service at block 205.

Services may be assigned to different data centers based on the particular requirements of the services. In an exemplary embodiment, at least two different classes of services may be supported, and each class of services may be placed using different methods. For example, a first class of services may include application critical services and a second class of services may include best effort services.

Application critical services may include services such as, for example, desktop services, storage services and communication services, however, application critical services are not limited thereto. As a result of high quality of service (QOS) requirements such as, for example, transmission delay and jitter per customer, application critical services model the service requirements per customer type at the time of deployment to identify potential customer locations based on the locations of the data centers.

Best effort services may include services such as, for example, bulk processing services (e.g., billing services, usage log processing and analysis services) and componential intensive grid-like services. Best effort services may utilize a point of deployment (POD) data center deployment approach, however, the deployment of best effort services is not limited thereto. In a POD data center deployment approach, potential POD locations are identified based on the local distribution of potential customers. For example, best effort services that are highly data intensive and/or retrieve data from outside the cloud (e.g., receive data at the customer's premises) may utilize a POD data center deployment approach in order to reduce the cost and/or time of accessing data. Best effort services that are not highly data intensive and/or retrieve data from the cloud may be deployed in the data center having the most unused resources.

The assignment of new services to data centers is subject to the hardware constraints of the data centers. For example, if a service utilizes certain hardware in order to function properly, the service will not be assigned to a data center that does not include that hardware. If a data center does not include the necessary hardware, or the necessary hardware is not properly configured, the OSS 102 may acquire or configure additional hardware to satisfy the new service. For example, a data center may power on or configure additional resources such as, for example, additional hardware, software, or network resources in order to satisfy the new service. Once the OSS 102 finds a data center having the hardware utilized by the new service, the new service is considered deployable and is added to the BSS services catalog of the OSS 102.

In an exemplary embodiment, complementary information such as, for example, information relating to customer location, service costs and QOS requirements can be utilized when deploying new services. For example, customer location information, service cost information and QOS requirement information may be used to calculate the cost of a potential customer based on the location of the customer. Thus, a service provider may use this information to determine whether to target customers in certain locations when deploying new services. As a result, new services may not be deployed in certain locations, and customers in those locations will not be able to subscribe to the new services. Further, a service provider may use this information to determine which data center is utilized to deploy a new service to a customer, based on the location of the customer.

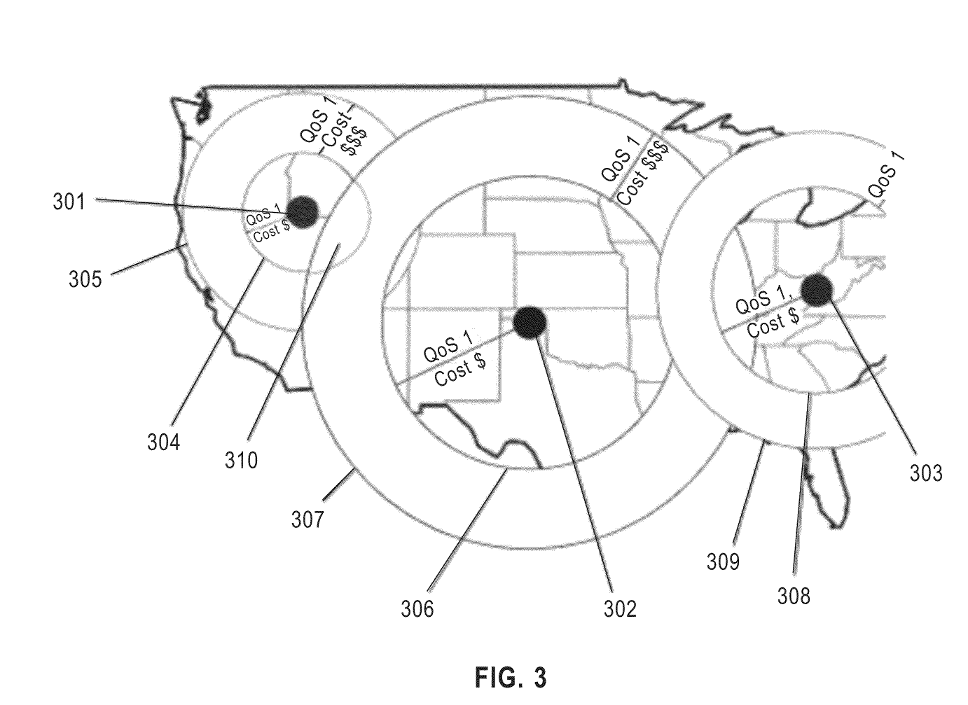

FIG. 3 illustrates the relationship between a latency QOS metric and geographic distance. For example, in FIG. 3, a service provider utilizes three data centers 301-303 for deploying services. This new service may be provided to a customer via the three data centers 301-303 at different costs depending on the location of the customer. For example, the use of additional bandwidth and additional proxies may be needed when the distance between a data center and a customer is large. FIG. 3 illustrates the cost distribution for a new service having a QOS requirement of about 90% (e.g., the service requires a response time within a range of about 90%) per potential customer, based on the location of the customer. Each data center 301-303 includes a first area 304, 306, 308 having a first service cost and a second area 305, 307, 309 having a second higher service cost. For customers located in an overlapping area of a high cost ($$$) and a low cost ($) service, e.g., area 310, service is more likely to be provisioned from the data center able to provide low cost service, e.g., 301. The final decision however will be taken at subscription time when the concrete customer requirements will be available.

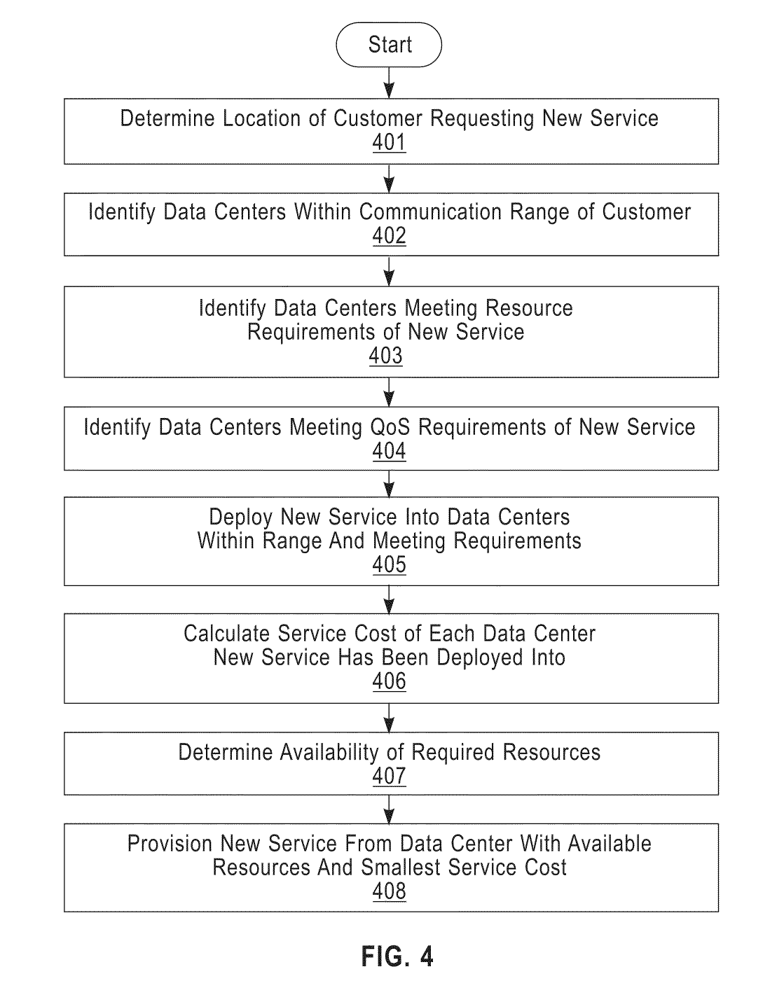

FIG. 4 illustrates a method of deploying new services based on customer location information, resource requirement information, QOS requirement information, and service cost information, according to an exemplary embodiment of the present disclosure. The location of a customer requesting a new service is determined at block 401. At block 402, data centers that are within a communication range of the customer are identified. At block 403, data centers meeting the resource requirements of the new service are identified. At block 404, data centers meeting the QOS requirements of the new service are identified. At block 405, the new service is deployed into the data centers that have been identified as being within the communication range of the customer, meeting the resource requirements of the new service, and meeting the QOS requirements of the new service. At block 406, the service cost is calculated for each data center that the new service has been deployed into. At block 407, the availability of the required resources at each data center that the new service has been deployed into is determined. At block 408, the new service is provisioned from the data center having available required resources and the smallest service cost.

Once a service is published in the BSS services catalog, the service is available for subscription. Resource allocation and provisioning occur when the service is subscribed to by a customer. Upon subscription of the service by a customer, customer requirements are collected and the costs of providing the customer with the subscribed service are calculated. This information is used to determine which data center is utilized to provide the customer with the service. For example, a valid data center(s) is selected by matching the customer requirements with the data center's available resources. If more than one valid data center is found, the data center with the minimum cost is selected for service provisioning.

The flowcharts and block diagrams in the figures illustrate the architecture, functionality, and operation of possible implementations of systems, methods and computer program products according to various embodiments of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

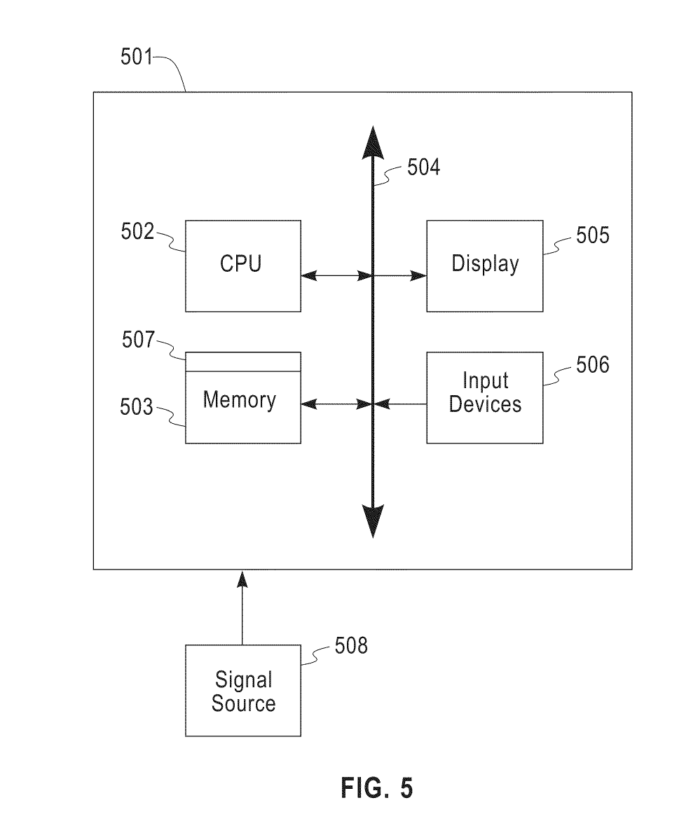

More particularly, referring to FIG. 5, according to an exemplary embodiment of the present disclosure, a computer system 501 for implementing a method for semi-automated service creation and optimized service mapping between a BSS and an OSS can comprise, inter alia, a central processing unit (CPU) 502, a memory 503 and an input/output (I/O) interface 504. The computer system 501 is generally coupled through the I/O interface 504 to a display 505 and various input devices 506 such as a mouse and keyboard. The support circuits can include circuits such as cache, power supplies, clock circuits, and a communications bus. The memory 503 can include random access memory (RAM), read only memory (ROM), disk drive, tape drive, etc., or a combination thereof. The present invention can be implemented as a routine 507 stored in memory 503 (e.g., a non-transitory computer-readable storage medium) and executed by the CPU 502 to process the signal from the signal source 408. As such, the computer system 501 is a general-purpose computer system that becomes a specific purpose computer system when executing the routine 507 of the present invention.

The computer platform 501 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

Having described embodiments for semi-automated service creation and optimized service mapping between a BSS and an OSS, it is noted that modifications and variations can be made by persons skilled in the art in light of the above teachings. It is therefore to be understood that changes may be made in exemplary embodiments of the disclosure, which are within the scope and spirit of the invention as defined by the appended claims. Having thus described the invention with the details and particularity required by the patent laws, what is claimed and desired protected by Letters Patent is set forth in the appended claims.

What is claimed is:

1. A non-transitory computer readable medium embodying instructions executed by a processor to perform a method for service creation and mapping between at least two support systems, comprising:
receiving a request for a new service, wherein the request includes resource requirement information and quality of service (QOS) requirement information corresponding to the new service;
determining a location that the request originated from;
identifying at least one data center within a communication range of the location;
identifying at least one data center having resources complying with the resource requirement information;
identifying at least one data center complying with the QOS requirement information; and
deploying the new service into each data center that is within the communication range of the location, that has resources complying with the resource requirement information, and that complies with the QOS requirement information.

2. The non-transitory computer readable medium of claim 1, further comprising:
calculating a service cost of each data center that the new service has been deployed into;
verifying availability of the resources complying with the resource requirement information at each data center; and
provisioning the new service from a data center having available resources complying with the resource requirement information and having the smallest service cost.

3. The non-transitory computer readable medium of claim 2, wherein the new service is provisioned at a time the new service is delivered to a customer.

4. The non-transitory computer readable medium of claim 1, wherein the at least two support systems include a business support system (BSS) and an operations support system (OSS).

5. The non-transitory computer readable medium of claim 4, wherein the BSS performs at least one of customer management, order management, revenue management and product management.

6. The non-transitory computer readable medium of claim 4, wherein the OSS deploys at least one operational service that processes a request for a data center from the BSS.

7. The non-transitory computer readable medium of claim 6, wherein the request from the BSS includes a request for at least one of virtual machine creation, virtual machine deletion, network reservation, storage reservation and image management.

8. The non-transitory computer readable medium of claim 6, wherein the OSS deploys the at least one operational service that processes a request for the data center from the BSS based on a configuration and a current state of the data center.

9. The non-transitory computer readable medium of claim 4, wherein deploying the new service into each data center that is within a communication range of the location, that has resources complying with the resource requirement information, and that complies with the QOS requirement information includes listing the new service in a services catalog in the BSS.

10. The non-transitory computer readable medium of claim 1, wherein the new service includes at least one application critical service.

11. The non-transitory computer readable medium of claim 10, wherein the at least one application critical service includes one of a desktop service, a storage service and a communication service.

12. The non-transitory computer readable medium of claim 1, wherein the new service includes at least one best effort service.

13. The non-transitory computer readable medium of claim 12, wherein the at least one best effort service includes one of a billing service, a usage log processing and analysis service and a componential intensive grid-like service.

14. The non-transitory computer readable medium of claim 12, wherein the at least one best effort service is deployed using a point of deployment (POD) data center deployment approach.

15. The non-transitory computer readable medium of claim 1, further comprising acquiring or configuring additional resources of a data center that is within a communication range of the location and that complies with the QOS requirement information in order to comply with the resource requirement information.

16. The non-transitory computer readable medium of claim 1, wherein the QOS requirement information includes at least one of a latency requirement and a bandwidth requirement.
